(19) United States
(12) Patent Application Publication
(10) Pub. No.: US 2020/0133234 A1
(43) Pub. Date: Apr. 30, 2020

(54) SYSTEMS AND METHODS FOR CONFIGURING AN ADDITIVE MANUFACTURING DEVICE

(71) Applicant: Avana Technologies, Inc., Westborough, MA (US)

(72) Inventor: Daniel Adam Theirl, Westborough, MA (US)

(21) Appl. No.: 16/661,713

(22) Filed: Oct. 23, 2019

Related U.S. Application Data
(60) Provisional application No. 62/750,234, filed on Oct. 24, 2018.

(51) Int. Cl. G05B 19/4099; G05B 19/4155

(52) U.S. Cl. CPC G05B 19/4099; G05B 2219/49007; G05B 19/4155

(57) ABSTRACT

This disclosure provides systems and methods for simplifying additive manufacturing. A user can interact with a simple user interface on a smartphone or other computing device to quickly and easily print a 3D object. In some implementations, a user may use an application executing on the computing device to select an object from a catalog of available objects. The user can be provided with a simple interface, such as a single button, for causing a 3D printer to print the selected object. In some implementations, the systems and methods of this disclosure can create a file having a preconfigured file format specific to the user's 3D printer, based on the object that the user selects to be printed. The preconfigured file can be automatically sent to the user's 3D printer and the 3D printer can automatically print the object according to the preconfigured file.

### CROSS-REFERENCE TO RELATED APPLICATION

This application claims priority to U.S. Provisional Patent Application No. 62/750,234, titled “SYSTEMS AND METHODS FOR CONFIGURING AN ADDITIVE MANUFACTURING DEVICE” and filed on Oct. 24, 2018, which is hereby incorporated by reference in its entirety.

### FIELD OF THE DISCLOSURE

This disclosure generally relates to additive manufacturing. In particular, this disclosure relates to simplifying the process of configuring an additive manufacturing device to produce a three-dimensional object.

### BACKGROUND OF THE DISCLOSURE

Producing a three-dimensional (3D) object via an additive manufacturing device (e.g., a 3D printer) requires technical knowledge to properly section a 3D model of the object and to properly configure the 3D printer. As a result, some users may not be able to use a 3D printer to produce a 3D object.

### BRIEF SUMMARY OF THE DISCLOSURE

Additive manufacturing, sometimes also referred to as three-dimensional (3D) printing, is a manufacturing technique in which an object is constructed based on a 3D model. In some implementations, the object is created by successive layer depositions of a material such as a liquid or gel that can be cured or otherwise solidified to construct the object. Subtractive processes, such as machining, cutting, drilling, and grinding typically are not used in additive manufacturing. Additive manufacturing can be carried out using a device referred to as a 3D printer, which can contain “ink” corresponding to the material used for the successive layer depositions as well as components used to successively deposit layers of the ink to build 3D objects.

3D printing may require technical knowledge to properly slice a computer file corresponding to a model of an object to be printed. For example, the model can be sectioned or sliced into pieces that each correspond to a particular one of the successive layers to be deposited to form the object. Various 3D printers may have different configuration settings, such as temperature, filler patterns, support material, print spacing between layers, etc. In addition, the way in which the model is sliced may depend on the particular geometry of the object and/or on the various configuration settings for the 3D printer. Slicing a computer file representing a 3D model can result in one or more new files that differ from the original model. For example, slicing the original 3D model computer file can result in a new file that uses a gcode format. This format can be downloaded from a computing device that was used to slice the original file, and can be transferred via an SD card or onboard memory to the 3D printer (e.g., if the printer does not have WIFI capabilities). These steps can require detailed technical knowledge that may not be accessible to many people.

This disclosure provides systems and methods for simplifying additive manufacturing. Using the systems and methods of the disclosure, a user can interact with a simple user interface on a smartphone or other computing device to quickly and easily print a 3D object. In some implementations, a user may use an application executing on the computing device to select an object from a catalog of available objects. The user can be provided with a simple interface, such as a single button, for causing a 3D printer to print the selected object. In some implementations, the systems and methods of this disclosure can create a file having a preconfigured file format specific to the user's 3D printer, based on the object that the user selects to be printed. The systems and methods of this disclosure can automatically send the preconfigured file to the user's 3D printer and cause the 3D printer to automatically print the object according to the preconfigured file. For example, in some implementations the user's 3D printer can be connected to a wireless network. A remote server can receive a request from the user to print an object (e.g., from the application executing on the user's computing device), and can then wirelessly transmit the corresponding preconfigured file to the user's 3D printer, thereby allowing the object to be printed without requiring the user to have any detailed knowledge of how to slice a model of the object or how to configure the settings of the 3D printer. In some implementations, the remote server can also communicate other information, such as one or more error messages or indications that the selected object has been printed successfully, to the user via the application executing on the user's computing device.

At least one aspect of this disclosure is directed to a system for manufacturing a three-dimensional (3D) object. The system can include a server intermediary to a 3D printer and a user computing device. The server can be configured to receive a plurality of raw data sets each corresponding to a respective 3D object. The server can be configured to store a set of configuration parameters for a 3D printer. The set of configuration parameters can correspond to settings of the 3D printer. The server can be configured to transform each raw data set of the plurality of raw data sets into a respective data file having a predetermined file format selected based on the set of configuration parameters for the 3D printer. Each data file can include information corresponding to images of a plurality of layers of the respective 3D object and printer instructions for manufacturing the respective 3D object using the 3D printer. The server can be configured to receive, from the user computing device, a request to build a selected one of the 3D objects. The server can be configured to transmit, to the 3D printer responsive to the request, the data file corresponding to the selected 3D object to cause the 3D printer to manufacture the selected 3D object based on the printer instructions included in the corresponding data file.

In some implementations, the server can be further configured to select a layer thickness for each raw data set of the plurality of raw data sets, based on the set of configuration parameters for the 3D printer. In some implementations, the server can be further configured to generate the images of the plurality of layers of each respective 3D object based on the selected layer thickness.

In some implementations, the set of configuration parameters for the 3D printer can include static data including at least one of a printer bed temperature, a printer bed size, a printer height, or a number of possible cartridges for the 3D printer. In some implementations, the set of configuration parameters for the 3D printer can include dynamic data including at least one of a volume of ink remaining in one or more cartridges, a type of ink in the one or more cartridges, a number of cartridges, or a real time temperature of a heatbed of the 3D printer.

In some implementations, the server can be further configured to generate, for at least one of the 3D objects, support material instructions corresponding to material to be included in negative space of the 3D object. In some implementations, the server can be further configured to generate the respective data file for the at least one 3D object to include the support material instructions.

In some implementations, the server can be further configured to generate each data file to include at least one of data rights management information and encryption information compatible with the predetermined file format.

In some implementations, the server can be further configured to provide a 3D printing application for installation on the user computing device. The 3D printing application can be configured to cause the user computing device to display a user interface including a catalog of the plurality of 3D objects. In some implementations, the server can be further configured to receive, from the user computing device, the request to build the selected one of the 3D objects responsive to a user interaction with the user interface displayed on the user computing device.

In some implementations, the server can be further configured to receive, from the user computing device, a second request to build a second selected 3D object. In some implementations, the server can be further configured to determine an error condition that prohibits the 3D printer from manufacturing the second selected 3D object, based on the second request and the set of configuration parameters for the 3D printer. In some implementations, the server can be further configured to transmit, responsive to determining the error condition, information to the user computing device to cause the user computing device to display an indication of the error condition.

In some implementations, the 3D printer can be a first 3D printer, and the server can be further configured to store a second set of configuration parameters for a second 3D printer. The second set of configuration parameters can correspond to settings of the second 3D printer. The server can also be configured to transform each raw data set of the plurality of raw data sets into a respective second data file having a second predetermined file format selected based on the second set of configuration parameters for the second 3D printer. Each second data file can include information corresponding to images of a plurality of layers of the respective 3D object and printer instructions for manufacturing the respective 3D object using the second 3D printer.

In some implementations, the user computing device can be a first user computing device, and the server can be further configured to receive, from a second user computing device, a second request to build a second selected one of the 3D objects. The server can also be configured to transmit, to the second 3D printer responsive to the second request, the second data file corresponding to the second selected 3D object to cause the second 3D printer to manufacture the second selected 3D object based on the printer instructions included in the corresponding second data file.

At least another aspect of this disclosure is directed to a method of manufacturing a 3D object. The method can include receiving, by a server, a plurality of raw data sets each corresponding to a respective 3D object. The method can include storing, by the server, a set of configuration parameters for a 3D printer. The set of configuration parameters can correspond to settings of the 3D printer. The method can include transforming, by the server, each raw data set of the plurality of raw data sets into a respective data file having a predetermined file format selected based on the set of configuration parameters for the 3D printer. Each data file can include information corresponding to images of a plurality of layers of the respective 3D object and printer instructions for manufacturing the respective 3D object using the 3D printer. The method can include receiving, by the server from a user computing device, a request to build a selected one of the 3D objects. The method can include transmitting, by the server to the 3D printer responsive to the request, the data file corresponding to the selected 3D object to cause the 3D printer to manufacture the selected 3D object based on the printer instructions included in the corresponding data file.

In some implementations, the method can include selecting, by the server, a layer thickness for each raw data set of the plurality of raw data sets, based on the set of configuration parameters for the 3D printer. In some implementations, the method can include generating, by the server, the images of the plurality of layers of each respective 3D object based on the selected layer thickness.

In some implementations, the set of configuration parameters for the 3D printer can include static data including at least one of a printer bed temperature, a printer bed size, a printer height, or a number of possible cartridges for the 3D printer. In some implementations, the set of configuration parameters for the 3D printer can also include dynamic data including at least one of a volume of ink remaining in one or more cartridges, a type of ink in the one or more cartridges, a number of cartridges, or a real time temperature of a heatbed of the 3D printer.

In some implementations, the method can include generating, by the server for at least one of the 3D objects, support material instructions corresponding to material to be included in negative space of the 3D object. In some implementations, the method can include generating, by the server, the respective data file for the at least one 3D object to include the support material instructions.

In some implementations, the method can include generating, by the server, each data file to include at least one of data rights management information and encryption information compatible with the predetermined file format.

In some implementations, the method can include providing a 3D printing application for installation on the user computing device. The 3D printing application can be configured to cause the user computing device to display a user interface including a catalog of the plurality of 3D objects. In some implementations, the method can include receiving, by the server from the user computing device, the request to build the selected one of the 3D objects responsive to a user interaction with the user interface displayed on the user computing device.

In some implementations, the method can include receiving, by the server from the user computing device, a second request to build a second selected 3D object. In some implementations, the method can include determining, by the server, an error condition that prohibits the 3D printer from manufacturing the second selected 3D object, based on the second request and the set of configuration parameters for the 3D printer. In some implementations, the method can include, responsive to determining the error condition, transmitting information by the server to the user computing device to cause the user computing device to display an indication of the error condition.

In some implementations, the 3D printer can be a first 3D printer, and the method can further include storing, by the server, a second set of configuration parameters for a second 3D printer. The second set of configuration parameters can correspond to settings of the second 3D printer. In some implementations, the method can also include transforming, by the server, each raw data set of the plurality of raw data sets into a respective second data file having a second predetermined file format selected based on the second set of configuration parameters for the second 3D printer. Each second data file can include information corresponding to images of a plurality of layers of the respective 3D object and printer instructions for manufacturing the respective 3D object using the second 3D printer.

In some implementations, the user computing device can be a first user computing device, and the method can further include receiving, by the server from a second user computing device, a second request to build a second selected one of the 3D objects. In some implementations, the method can also include transmitting, by the server to the second 3D printer responsive to the second request, the second data file corresponding to the second selected 3D object to cause the second 3D printer to manufacture the second selected 3D object based on the printer instructions included in the corresponding second data file.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising a client device in communication with a server device;

FIG. 1B is a block diagram depicting a cloud computing environment comprising a client device in communication with cloud service providers;

FIGS. 1C and 1D are block diagrams depicting embodiments of computing devices useful in connection with the methods and systems described herein.

FIG. 2 depicts some of the architecture of an implementation of a system configured to allow a user to print a three-dimensional (3D) object.

FIG. 3 depicts a flowchart of an implementation of a method for printing a 3D object.

FIGS. 4A-4K depict example user interfaces that can be provided in connection with the system of FIG. 2 and the method of FIG. 3.

FIG. 5 depicts a flowchart of an implementation of a method for manufacturing a 3D object.

### DETAILED DESCRIPTION

For purposes of reading the description of the various embodiments below, the following descriptions of the sections of the specification and their respective contents may be helpful:

Section A describes a network environment and computing environment which may be useful for practicing embodiments described herein.

Section B describes techniques for configuring an additive manufacturing device.

### A. Computing and Network Environment

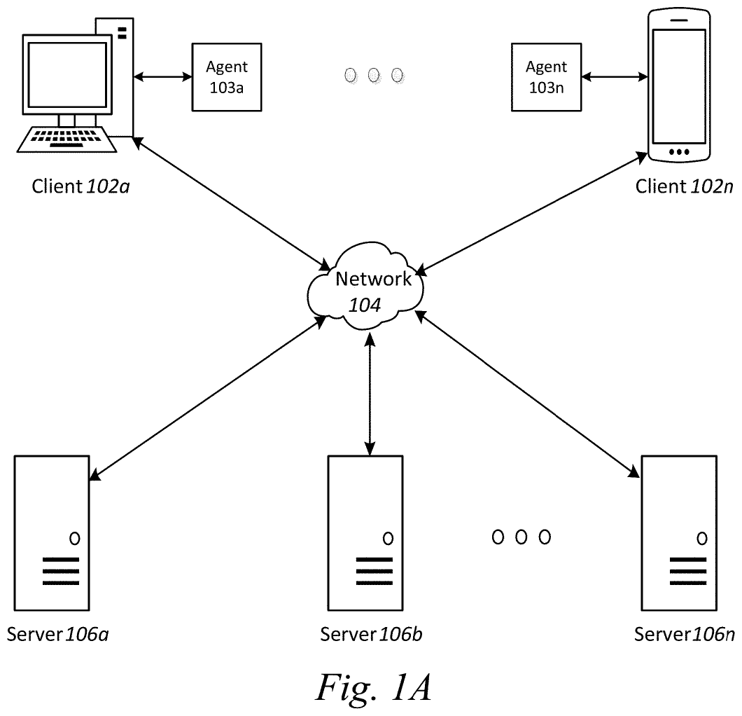

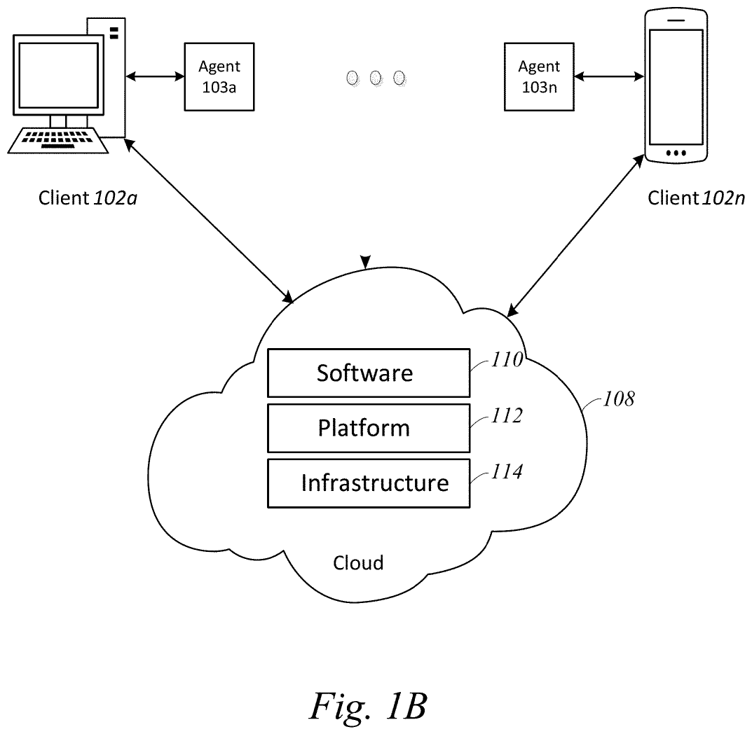

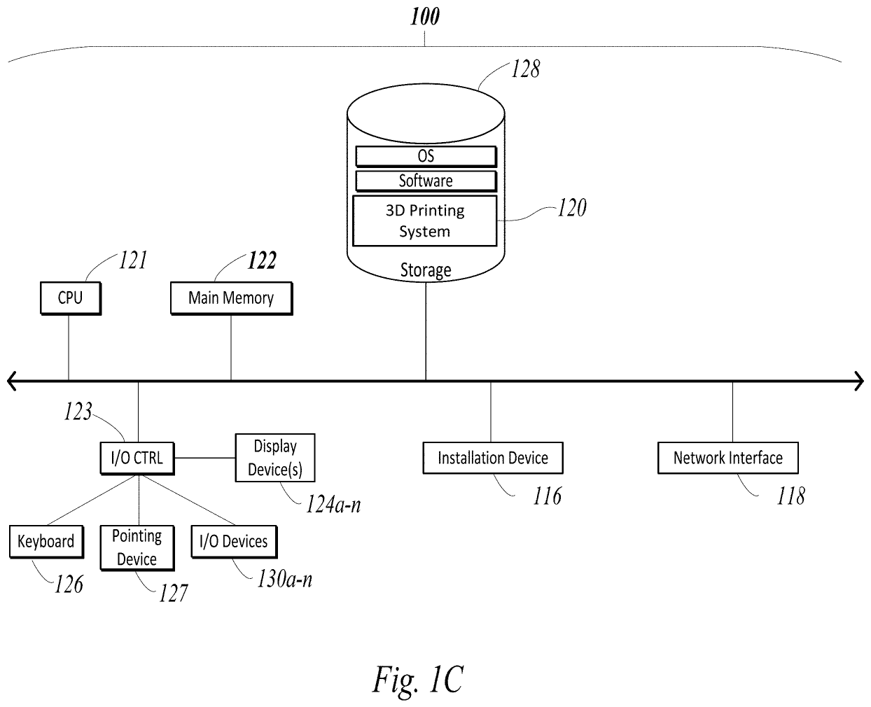

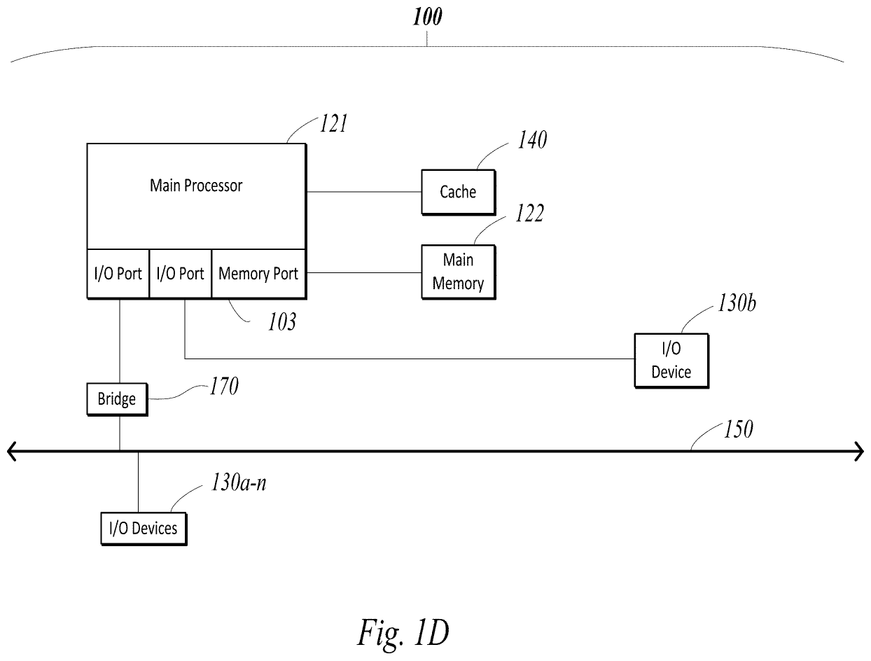

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more agents 103a-103n and one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically-grouped servers 106. In one of these embodiments, the logical group of servers may be referred to as a server farm 38 (not shown) or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix, Linux, or Mac OS X).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

Referring to FIG. 1B, a cloud computing environment is depicted. A cloud computing environment may provide client 102 with one or more resources provided by a network environment. The cloud computing environment may include one or more clients 102a-102n, in communication with respective agents 103a-103n and with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 102 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, an operating system, software, and a three-dimensional (3D) printing system 120. As shown in FIG. 1D, each computing device 100 may also include additional optional elements, e.g. a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of a multi-core processors include the AMD PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAIVI), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augment reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopic. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the 3D printing system 120. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via a I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as an installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Wash.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is an eBook reader, e.g. the KINDLE family of devices by Amazon.com, or NOOK family of devices by Barnes & Noble, Inc. of New York City, N.Y.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Techniques for Configuring an Additive Manufacturing Device

Additive manufacturing, also referred to herein as three-dimensional (3D) printing, is a manufacturing technique in which an object is constructed based on a 3D model. In some implementations, the object is created by successive layer depositions of a material such as a liquid or gel that can be cured or otherwise solidified to construct the object. Subtractive processes, such as machining, cutting, drilling, and grinding typically are not used in additive manufacturing. Additive manufacturing can be carried out using a device referred to as a 3D printer, which can contain “ink” corresponding to the material used for the successive layer depositions as well as components used to successively deposit layers of the ink to build 3D objects.

3D printing may require technical knowledge to properly slice a computer file corresponding to a model of an object to be printed. For example, the model can be sectioned or sliced into pieces that each correspond to a particular one of the successive layers to be deposited to form the object. Various 3D printers may have different configuration settings, such as temperature, filler patterns, support material, print spacing between layers, etc. In addition, the way in which the model is sliced may depend on the particular geometry of the object and/or on the various configuration settings for the 3D printer. Slicing a computer file representing a 3D model can result in one or more new files that differ from the original model. For example, slicing the original 3D model computer file can result in a new file that uses a gcode format. This format can be downloaded from a computing that was used to slice the original file, and can be transferred via an SD card or onboard memory to the 3D printer (e.g., if the printer does not have WIFI capabilities). These steps can require detailed technical knowledge that may not be accessible to many people.

This disclosure provides systems and methods for simplifying additive manufacturing. Using the systems and methods of the disclosure, a user can interact with a simple user interface on a smartphone or other computing device to quickly and easily print a 3D object. In some implementations, a user may use an application executing on the computing device to select an object from a catalog of available objects. The user can be provided with a simple interface, such as a single button, for causing a 3D printer to print the selected object.

In some implementations, the systems and methods of this disclosure can create a file having a preconfigured file format specific to the user's 3D printer, based on the object that the user selects to be printed. The systems and methods of this disclosure can automatically send the preconfigured file to the user's 3D printer and cause the 3D printer to automatically print the object according to the preconfigured file. For example, in some implementations the user's 3D printer can be connected to a wireless network. A remote server can receive a request from the user to print an object (e.g., from the application executing on the user's computing device), and can then wirelessly transmit the corresponding preconfigured file to the user's 3D printer, thereby allowing the object to be printed without requiring the user to have any detailed knowledge of how to slice a model of the object or how to configure the settings of the 3D printer. In some implementations, the remote server can also communicate other information, such as one or more error messages or indications that the selected object has been printed successfully, to the user via the application executing on the user's computing device.

In some implementations, the systems and methods of this disclosure can use inputs such as the preconfigured file with instructions on how to print each layer of a particular object that a particular printer (e.g., the printer owned by the user) can interpret. This file can be a gcode file, which can be converted into byte code and encrypted to ensure low latency and low storage requirements between the user's computing device, cloud (e.g., on the remote server), and the user's 3D printer. For example, the server can receive an order from an identified unique user to download and print a particular 3D model. In some implementations, the user can make the order using the application executing on the user's computing device (e.g., by selecting the object from a catalog of available objects). The server can use a file format that contains the encrypted, compressed and preconfigured file and can transmit the file to the user's 3D printer. The 3D printer can receive the file and can automatically decrypt and decompress the file. The 3D printer can immediately begin to print the object using the proper materials (e.g., inks) and printer configuration settings.

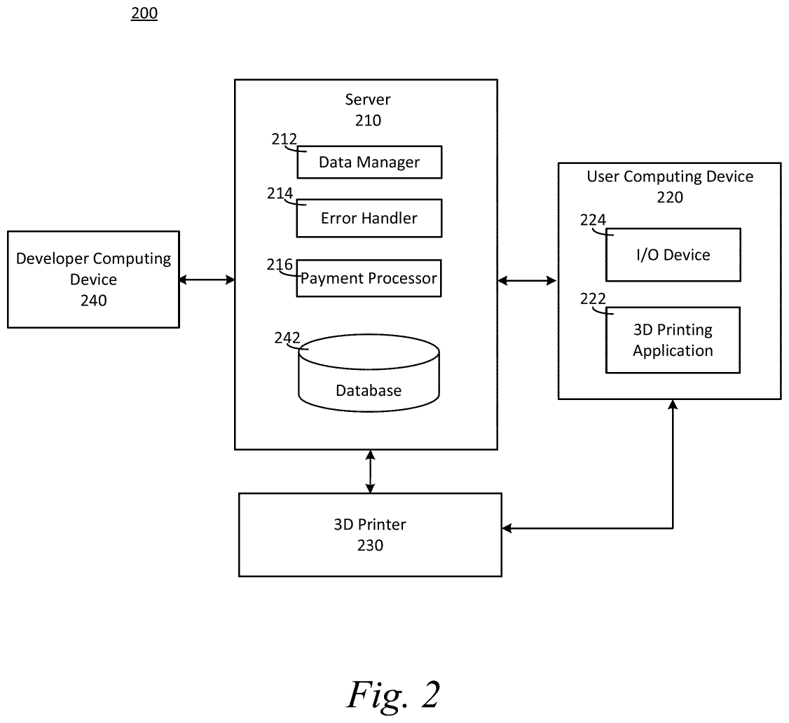

Referring now to FIG. 2, the system 200 can be configured to allow a user to print a 3D object. The system 200 includes a server 210, a user computing device 220, a 3D printer 230, and a developer computing device 240. The server 210, the user computing device 220, and the 3D printer 230 can be configured to communicate with one another. For example, the server 210, the user computing device 220, and the 3D printer 230 can be configured to communicate via one or more wired or wireless networks, such as a home WiFi network and/or the Internet. The developer computing device 240 also can be configured to communicate with the server 210 via one or more wired or wireless networks.

In some implementations, the components of the system 200 can include or can be implemented using the systems and devices described above in connection with FIGS. 1A-1D. For example, any of the user computing device 220, the 3D printer 230, and the developer computing device 240 may correspond to one of the agents 103a-103n shown in FIGS. 1A and 1B or one of the clients 102a-102n, and the server 210 may correspond to one of the servers 106a-106n. Similarly, any of the components of the system 200 may be implemented using computing devices similar to those shown in FIGS. 1C and 1D and may include any of the features of those devices, such as the CPU 121, the memory 122, the I/O devices 130a-130n, the network interface 118, etc.

The user computing device 220 can be any type of computing device owned, operated, or otherwise associated with a user, who may be any individual or group of individuals interested in printing objects via the 3D printer 230. For example, the user computing device 220 can be a mobile phone, a tablet computing device, a laptop computing device, or a desktop computing device. To allow the user to easily browse objects and select objects for printing by the 3D printer 230, the user computing device 230 executes a 3D printing application 222.

The 3D printing application 222 can be any type or form of software capable of executing on the user computing device 220, and may be configured to execute at all times while the user computing device 220 is powered on. The 3D printing application 222 can be configured to provide a user interface to the user, for example via at least one input/output (I/O) device 224. In some implementations, the I/O device 224 can be or can include an electronic display for display information to the user. The I/O device 224 can also include one or more speakers, microphones, touchscreen interfaces, pointing devices, keyboards, or any other device or combination of devices for providing output to the user or receiving input from the user. In some implementations, the interface provided via the 3D printing application 222 can allow a user to browse through a virtual catalog of objects for which 3D models have already been created. For example, a developer may use the developer computing device 240 to develop and upload one or more 3D models to the server 210.

The server 210 can store the 3D models, for example in the database 242. The 3D printing application 222 executing on the user computing device 220 can receive a list of available 3D models from the server 210, and can present the list to the user of the user computing device 220. The 3D printing application 220 can also allow the user to select one or more of the available 3D models, and can communicate the selection to the server 210. The server 210 can then instruct the 3D printer to print the object automatically, without any need for receiving configuration information from the user. In some implementations, the 3D printing application 222 can also perform other functions, such as allowing a user to create an account and processing a payment from the user (e.g., a purchase of one or more stored 3D models). These and other functions or the 3D printing application 222, along with example user interfaces that can be provided by the 3D printing application 222, are described further below.

The server 210 can be configured to simplify the process by which the user selects and prints objects using the 3D printer. For example, the server 210 can perform functions that hide or abstract certain technical details from the user, such as details relating to slicing of a selected 3D model and setting various configuration parameters for the 3D printer 230. The server 210 includes a data manager 212, an error handler 214, a payment processor 216, and the database 242.

The data manager 212 can be configured to receive and transmit data to and from the user computing device 220, the 3D printer 230, and the developer computing device 240. The data manager 212 can also be configured to manipulate or transform data, and to store and retrieve data from the database 242. For example, in some implementations the data manager 212 can be configured to store a dataset relating to configuration parameters or other settings of the 3D printer 230. This dataset can describe qualities of the 3D printer 230 by version. The data manager 212 can store this data in a persistent manner (e.g., in the database 242 or in other cloud storage accessible to the server 210 through a secure internet connection). The dataset for the 3D printer 230 can include 3D printer settings such as printer bed temperature, printer bed size, printer height, number of possible cartridges, etc., and may be organized by version. In some implementations, the data manager 212 can use this dataset to determine at what scale and how to print a given 3D object using the 3D printer 230, which may differ from other 3D printers having different configurations and settings.

In some implementations, the data manager 212 can also be configured to receive transient or dynamic data from the 3D printer 230. Transient or dynamic data can include data that may change over time, unlike the settings and configuration data which may remain static. For example, dynamic data from the 3D printer 230 may include any data relating to a volume of ink left in one or more cartridges of the 3D printer 230 (e.g., an inkVolume data field), a type of ink in each cartridge (e.g., an inkType data field), a number of cartridges (e.g., a cartridgeCount data field), a real time temperature of a heatbed of the 3D printer 230 (e.g., a heatbedTemp data field), etc. In some implementations, the data manager 212 can use this data to determine the final configuration settings in a preconfigured file created on the server 210. For example, in some implementations the server 210 can receive raw data for a 3D model from the developer computing device 240. In some implementations, a developer may upload the raw data for the 3D model to the server 210 using a virtual marketplace provided by the server 210. The data manager 210 can transform the raw data from the 3D model into the preconfigured file format.

The preconfigured file format can be selected to be compatible with the 3D printer 230, and to take into account the configuration settings and other data specific to the 3D printer 230. As a result, the preconfigured file format can be useable by the 3D printer 230 without any alterations to the preconfigured file or to the 3D printer 230. In some implementations, the data manager 212 can verify that a raw data file corresponding to a 3D model provided via the developer computing device 240 is complete and contains all necessary information. If there is an error at this point, the error handler 214 can notify the developer of the error (e.g., by providing an alert notification to the developer computing device 240), so that the developer can fix the error and re-upload the file.

Once the data manager 212 has verified the file, the data manager 212 can automatically slice the file into layers of images. For example, the images may be in formats such as SVG or PNG. In some implementations, the data manager 212 can select parameters for the slicing, such as layer thickness, based on the configuration data for the 3D printer 230. The data manager 212 can also add support material instructions (e.g., instructions for adding additional material in negative space of the model for additional structural support) to the file if necessary or desired based on the particular geometry of the 3D model. The sliced set of images can be stored as static data (e.g., in the database 242), but the final preconfigured file with final printer instructions can be recalled in a logical print order. In some implementations, the preconfigured file format may have additional built in features for proprietary product designs, such as data rights management, encryption, and higher quality details such as options for material types and colors.

In some implementations, the error handler 214 can also provide a “Go” or “No Go” signal to the 3D printer 230 and/or the user computing device 220 to report one or more error messages back to the user using this dynamic data. For example, if the dynamic data indicate that the ink volume in the 3D Printer 230 is low, the error handler 214 can send an indication of this condition to the user computing device 220. The information can be displayed on the user computing device 220, e.g., via the 3D printing application 222.

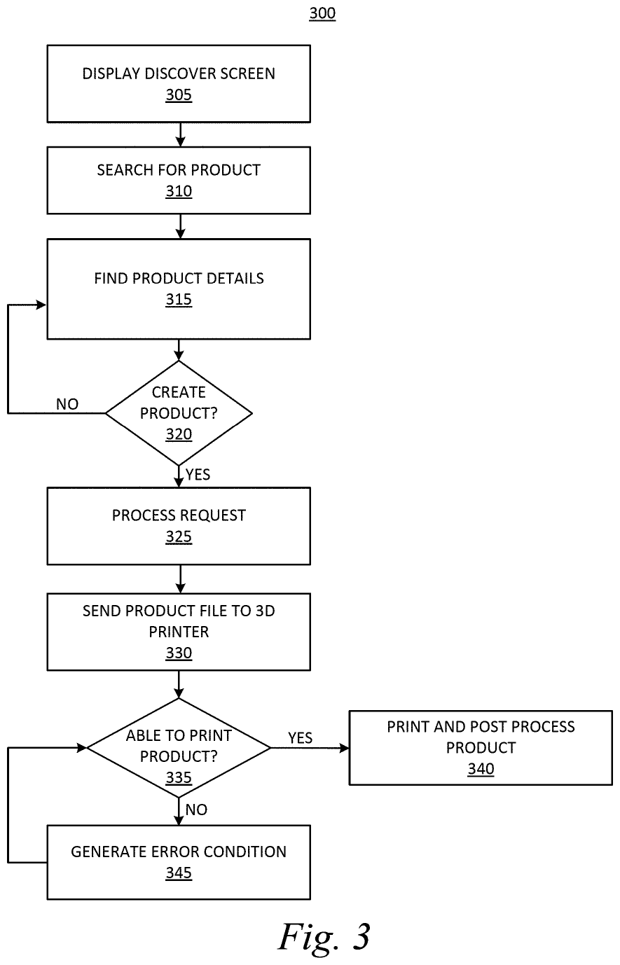

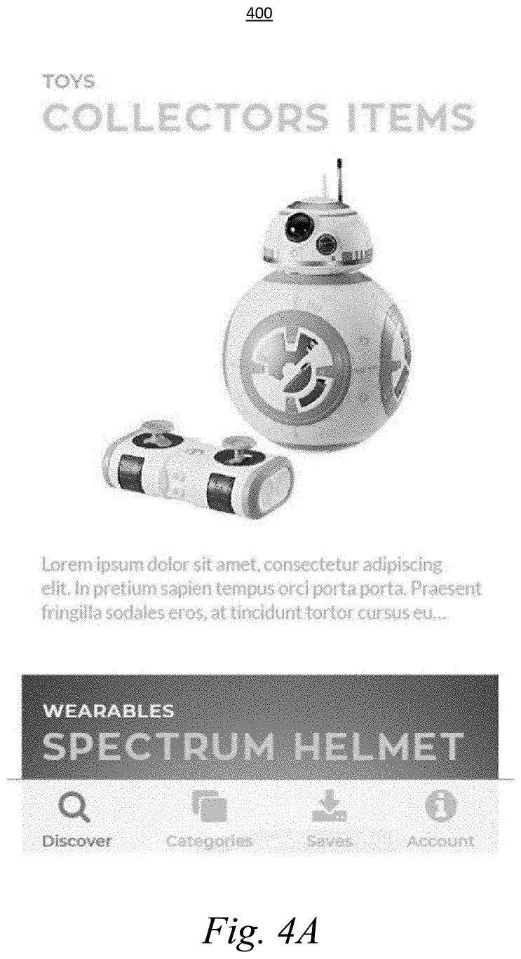

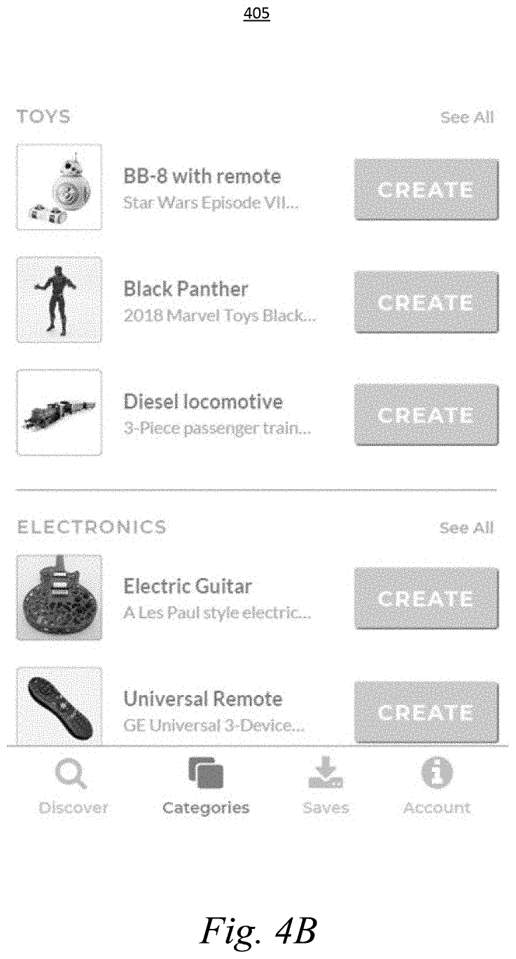

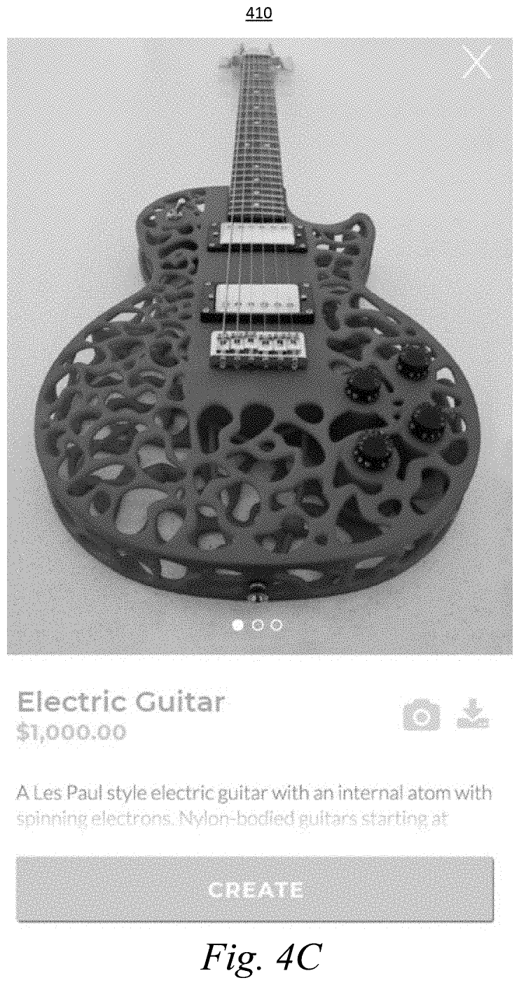

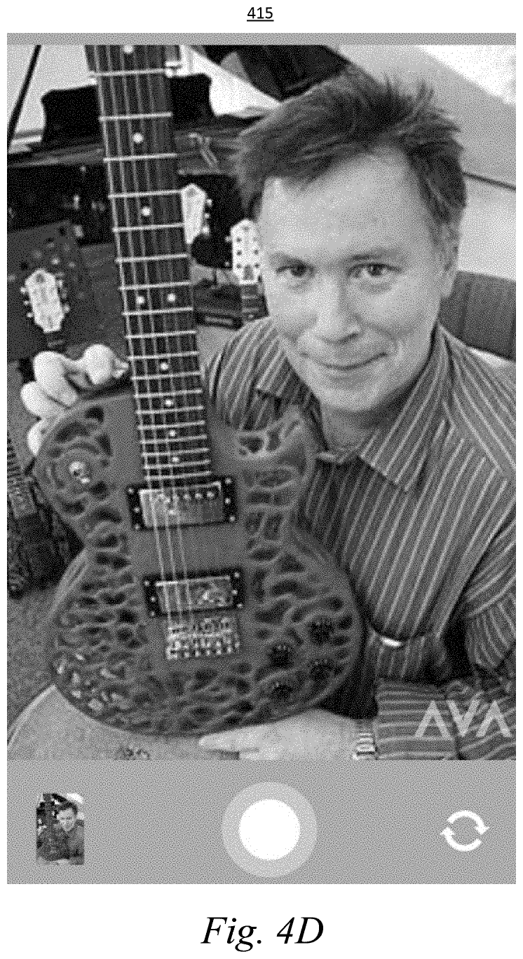

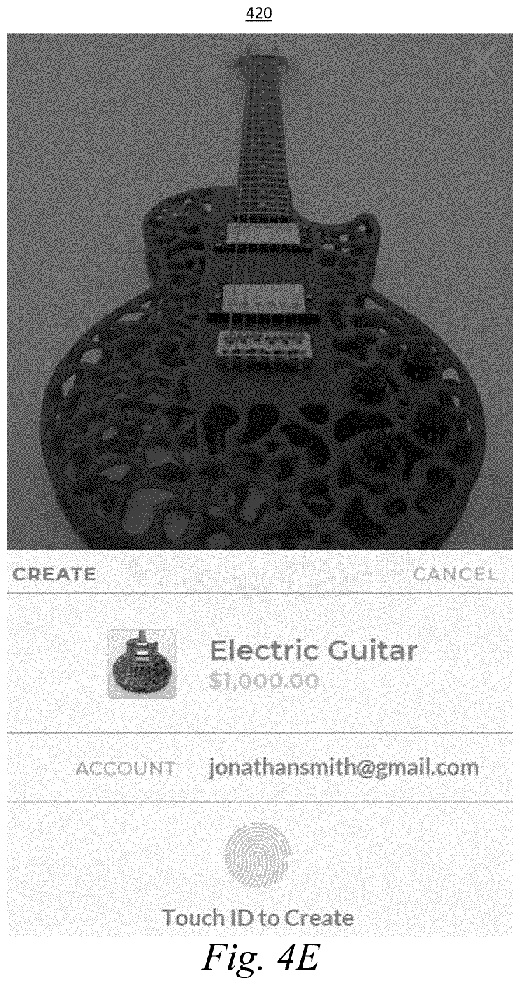

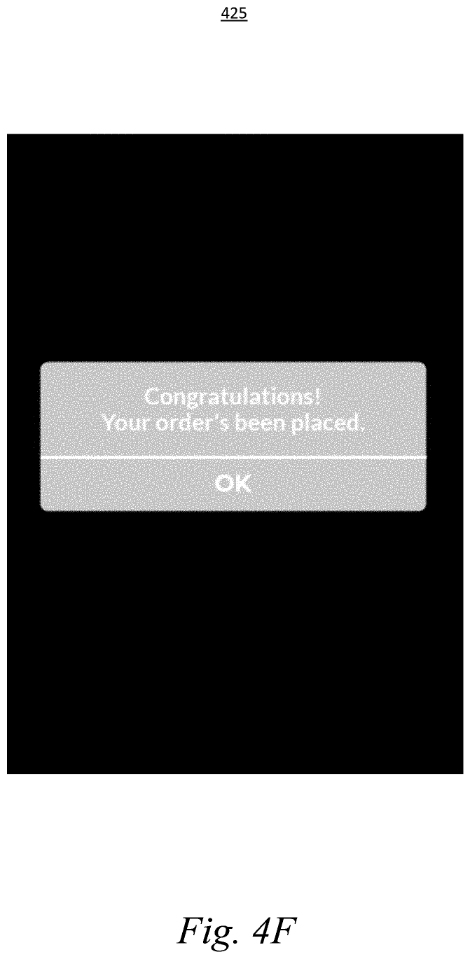

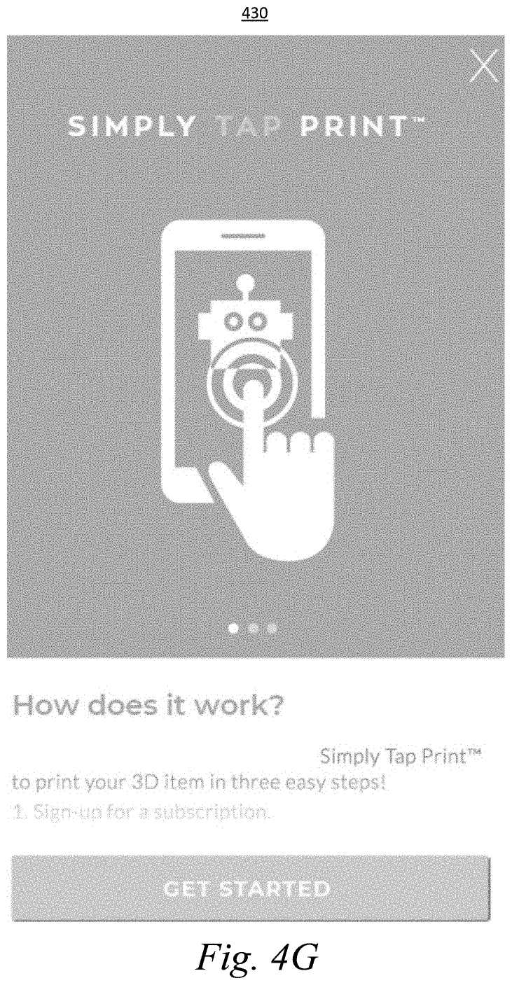

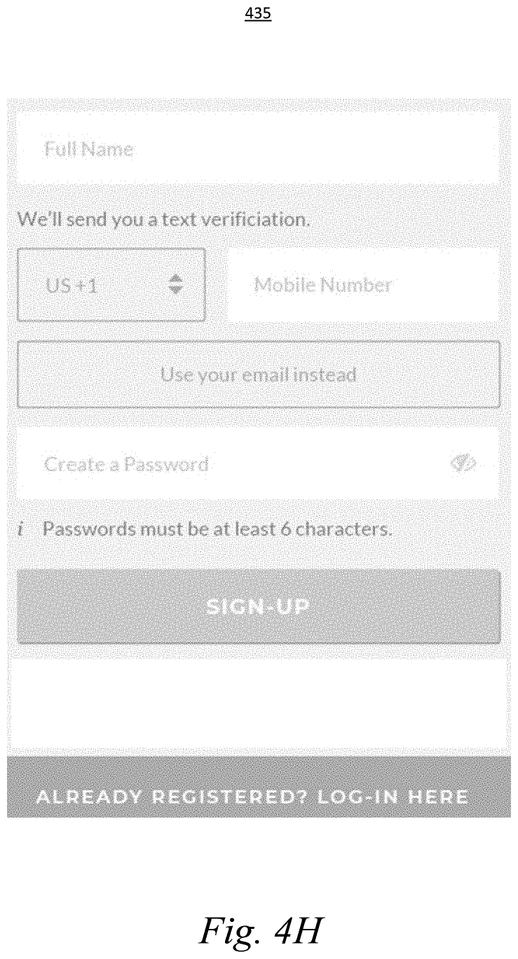

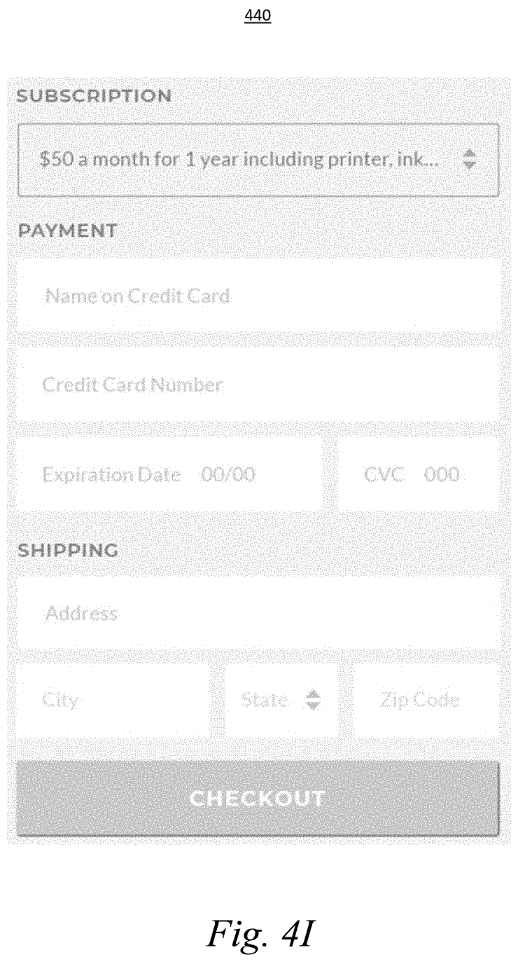

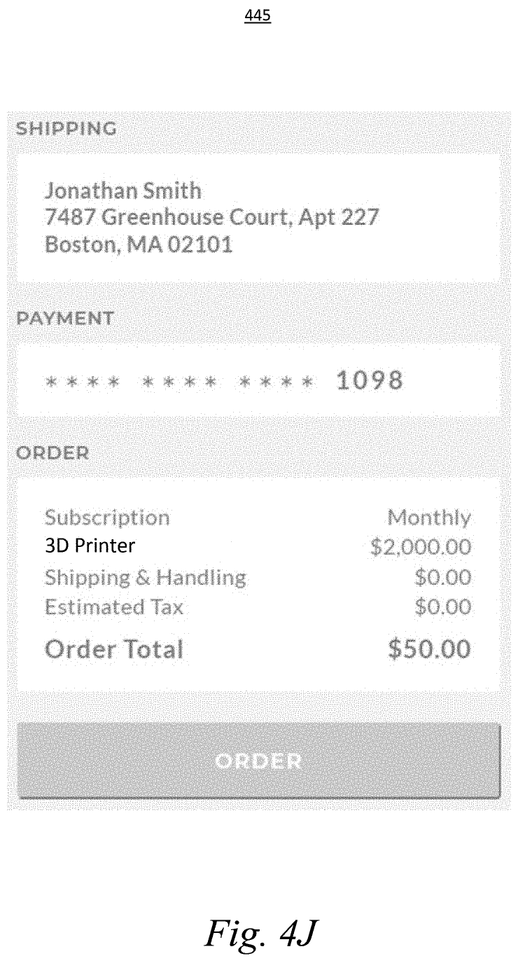

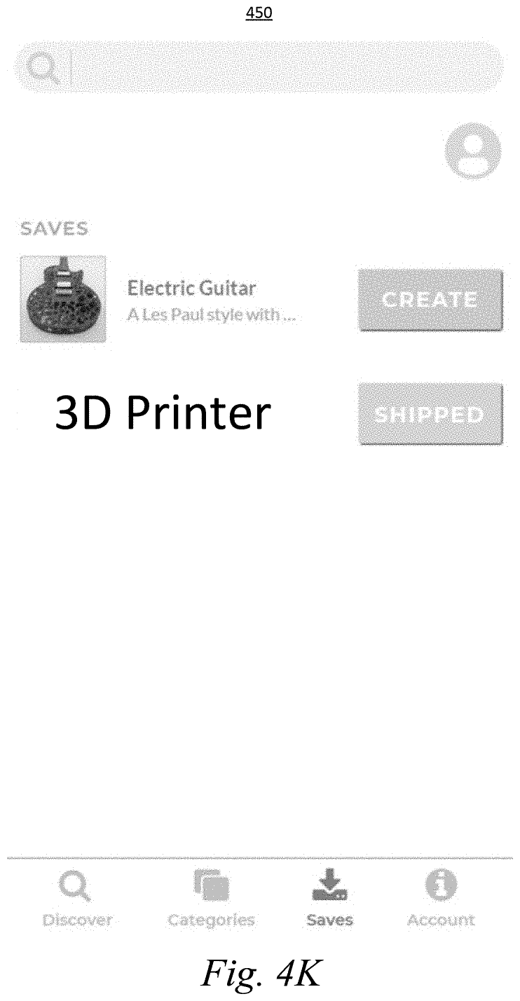

FIG. 3 depicts a flowchart of an implementation of a method 300 for printing a 3D object. FIGS. 4A-4K depict example user interfaces that can be provided in connection with the system 200 of FIG. 2 and the method 300 of FIG. 3. FIGS. 3 and 4A-4K are described together below.

Referring to FIG. 3, the method 300 can include displaying a “discover” screen (BLOCK 305). In some implementations, the “discover” screen can be displayed on the user computing device 220 of FIG. 2, for example via the 3D printing application 222. FIG. 4A depicts a graphical user interface (GUI) 400 that can correspond to the “discover” screen. As shown in FIG. 4A, the GUI 400 include one or more items (in the example shown, “collectors' items” are displayed on the screen). In some implementations, the “discover” screen can include a scrollable list of products or items that a user may browse through. Generally, the products can be any objects for which 3D models are available to be printed via the 3D printer 230 of FIG. 2.

The method 300 can also include searching for a product (BLOCK 310). For example, the user can search for a product via the “discover” screen displayed in BLOCK 305. In some implementations, the user may be presented with an interface having a search field into which the user can enter a text-based query to find a product. In some implementations, the user can select a “categories” button (e.g., the “categories” button shown on the lower left hand side of FIG. 4A) to be presented with a “categories” GUI 405 as shown in FIG. 4B. For example, the “categories” GUI may present a scrollable list of products organized into categories, such as toys and electronics.

The method 300 can include finding product details (BLOCK 315). In some implementations, the user can choose to find product details via the “discover” screen, the “categories” screen, or any other type of search screen on which products are displayed. For example, by selecting one of the displayed products (e.g., with a touch input or pointing device), the user can be shown a product details screen as illustrated in the GUI 410 of FIG. 4C. The GUI 410 corresponds to product details for a selected electric guitar. The product details can include one or more photographs of the product, as well as a description of the product and a cost for the product. The GUI 415 of FIG. 4D also shows an additional product details screen, which includes an additional photograph of the selected electric guitar.

The method 300 can include determining whether to create the product via the 3D printer (BLOCK 320). For example, the user may choose to create a product by selecting a “create” button, such as the button shown in the lower portion of the GUI 410 of FIG. 4C that displays product details for the electric guitar. If the user does not wish to create the product, the method 300 can return to BLOCK 315. If the user does wish to create the product, the user can be presented with an authentication GUI such as the authentication GUI 420 of FIG. 4E. The authentication GUI can prompt the user to enter biometric information such as a fingerprint or facial scan, or to enter a password or other credentials to complete a purchase of the product and cause the product to be created.

In some implementations, upon successful authentication, the method 300 can proceed to BLOCK 325, in which the request is processed. For example, the payment processor 216 of FIG. 2 can process a payment associated with the product by billing the user for an amount equal to the price of the product. In some implementations, the payment processor 216 can store payment information, such as a credit card or other financial account information for the user, in order to complete the payment. Processing the request (BLOCK 325) can also include displaying an indication to the user that the order was placed successfully. For example, such an indication can be provided by an interface such as the GUI 425 shown in FIG. 4F. Processing the request (BLOCK 325) can also include creating or retrieving the preconfigured file corresponding to the 3D model of the product selected for creation by the user in BLOCK 320. For example, as described above, the data manager 212 of FIG. 2 can manipulate or transform raw data corresponding to a 3D model of the product according to a set of data for the 3D printer 230, which can include configuration settings, printer capabilities, software versions, compatibility information, etc. Thus, the data manager 212 can produce one or more files corresponding to the product in a format that can be interpreted by the 3D printer 230 without any additional input from the user.

The method 300 can include sending the one or more product files to the 3D printer (BLOCK 330). In some implementations, the one or more product files can be transmitted to the 3D printer automatically via a wireless network. The user may not have to take any additional action to cause the one or more files to be sent to the 3D printer.

At BLOCK 335, the method 300 can include determining whether the 3D printer is able to print the product. For example, the 3D printer may be unable to print the product if the 3D printer is out of ink or if the 3D printer otherwise lacks a capability required to accurately reproduce the product (e.g., if the 3D printer does not have sufficient printing resolution or a print bed large enough for the product to be built).

In some implementations, sending the one or more files to the 3D printer can also cause the 3D printer to automatically attempt to begin printing the product. For example, the 3D printer can actively listen for files formatted according to the preconfigured format from verified user devices (e.g., the server 210 or the user computing device 230 of FIG. 2). When the 3D printer receives such a file, the 3D printer can automatically decrypt, unpack, and process the printing instructions contained in the file to quickly print and optionally post process the desired product (BLOCK 340). In some implementations, the 3D printer can report back status updates or errors (e.g., to the server 210 or the user computing device 220).

If the product cannot be printed, the method 300 can include generating an error condition (BLOCK 345). For example, the error handler 214 can transmit a notification of any error encountered to the user computing device 220 for display to the user. In some implementations, an error may also be generated by the 3D printer itself, which may transmit a notification of the error to either or both of the server 210 and the user computing device 220.

A variety of other user interface screens not described in connection with the method 300 may also be displayed to the user to enable different functionality. For example, as shown in FIG. 4G, a GUI 430 may be displayed for introducing the system to a new user. The GUI 430 may provide a brief overview of the functioning of the system, and can include a “get started” button that a new user can select to initiate the process of selecting and printing objects.

FIG. 4H shows a GUI 435 for allowing a new user to create an account. For example, via the GUI 435, the user can enter a name, phone number, and password, and can select the “sign-up” button to create an account. In some implementations, information entered via the GUI 435 by the user can be transmitted to the server 210 and saved in the database 242. FIG. 4I shows a GUI 440 for allowing a user to enter payment and shipping information. In some implementations, the user may enter credit card information as shown. In some other implementations, the user may enter other financial account information, such as Google Pay, Apple Pay, or other mobile wallet credentials. This payment information can be saved for later use so that future payments can be processed automatically with the user's consent via authentication as described in connection with the GUI 420 of FIG. 4E.

Upon initial sign-up, the user may also select a subscription plan as shown in FIG. 4I. For example, the plan can include any combination of a 3D printer, ink, and access to products in the catalog for a period of time. Upon selecting the checkout button in the GUI 440 of FIG. 4I, the user may be presented with confirmation information as shown in the GUI 445 of FIG. 4J. The user may select the “order” button to confirm the purchase.

In some implementations, the user may also be able to view products to be saved without making a purchase immediately. For example, as shown in the GUI 450 of FIG. 4K, a list of saved products can be associated with the user's account and displayed to the user on a “saves” screen. Saved items can include items that the user has previously paid for. In some implementations, the user may be able to print any number of additional instances of a saved item, even after printing it a first time.

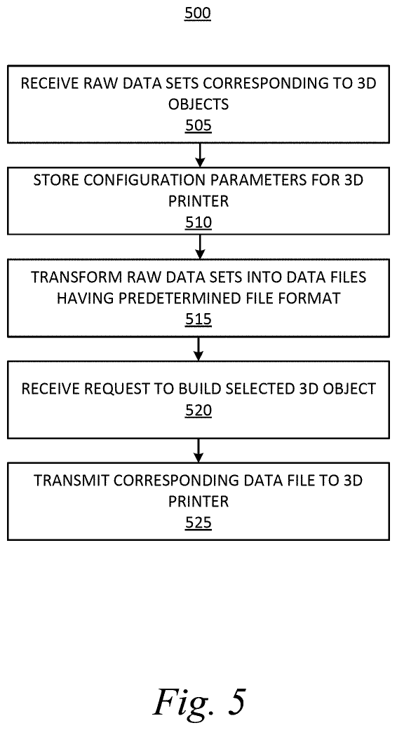

FIG. 5 depicts a flowchart of an implementation of a method 500 for manufacturing a 3D object. In brief overview, the method 500 can include receiving a plurality of raw data sets each corresponding to a respective 3D object (BLOCK 505). The method can include storing a set of configuration parameters for a 3D printer (BLOCK 510). The method can include transforming each raw data set into a respective data file having a predetermined file format (BLOCK 515). The method can include receiving a request to build a selected one of the 3D objects (BLOCK 520). The method can include transmitting the corresponding data file to the 3D printer (BLOCK 525).

Referring again to FIG. 5, and in greater detail, the method 500 can include receiving a plurality of raw data sets each corresponding to a respective 3D object (BLOCK 505). In some implementations, the raw data sets can be received by a server such as the server 210 shown in FIG. 2. The raw data sets can be generated and provided to the server by one or more developers. For example, a developer can generate a raw data set for a 3D object using a computing device such as the developer computing device 240, and can use the computing device to transmit the raw data set to the server 210.

In some implementations, a raw data set can include information about its respective 3D object as a whole. For example, the raw data set can include information that identifies the shape and geometry of a 3D object. In some implementations, a raw data set can also include information relating to negative space of the 3D object. However, in some implementations a raw data set may not include information relating to any technique for manufacturing the 3D object. For example, the raw data set for a 3D object may not include any information relating to the layers or slices of the object that could be sequentially deposited to form the entire 3D object using a 3D printer. In some implementations, the raw data set also may not include information relating to materials to be used or other parameters to be used in constructing the 3D object.

The method can include storing a set of configuration parameters for a 3D printer (BLOCK 510). In some implementations, the configuration parameters can be stored in a database such as the database 242 of the server 210 shown in FIG. 2. The configuration parameters can correspond to various settings of the 3D printer. For example, at least some of the configuration parameters can include information relating to 3D printer settings such as a printer bed temperature, a printer bed size, a printer height, and a number of possible cartridges. In some implementations, the configuration parameters may include information relating to a model name, a model number, or a serial number of the 3D printer. Such information can be considered static, as it may not change over time. In some implementations, the data manager 212 can be configured to store the configuration settings for the 3D printer in a persistent manner. In some implementations, the server may store configuration parameters for additional 3D printers as well.

In some implementations, the configuration parameters can also include information that may change over time. Such information can be referred to in this disclosure as transient or dynamic data. For example, such data may include any data relating to a volume of ink left in one or more cartridges of the 3D printer, a type of ink in each cartridge, a number of cartridges, a real time temperature of a heatbed of the 3D printer, a real time temperature of a nozzle of the 3D printer, etc.

In some implementations, there may be more than one type of 3D printer with which the server can interact. Thus, the server may also store at least a second set of configuration parameters for a second 3D printer. Like the first set of configuration parameters, the second set of configuration parameters can correspond to settings of the second 3D printer, which may differ from those of the first 3D printer. In general, the server can store respective sets of configuration parameters for any number of printers. At least some of the 3D printers can make use of different additive manufacturing techniques. For example, the 3D printers may include one or more 3D printers that form a product using a material extrusion process, such as fused deposition modeling or fused filament modeling. The 3D printers can also include one or more 3D printers that form a product using a vat polymerization process, such as stereolithography or direct light processing. The 3D printers can also include one or more 3D printers that form a product using a power bed fusion process, such as selective laser sintering, selective laser melting, direct metal laser sintering, or electron beam melting. The 3D printers can also include one or more 3D printers that form a product using a material jetting or drop-on-demand (DOD) process. The 3D printers can also include one or more 3D printers that form a product using a binder jetting, sand binder jetting, or metal binder jetting process.

It should be understood that the additive manufacturing process used by a particular 3D printer may require a respective set of configuration parameters or settings, which may be different from the configuration parameters or settings of 3D printers that form a product using a different additive manufacturing process. For example, a 3D printer that uses a material extrusion process, such as fused deposition modeling or fused filament modeling, may include a nozzle that is heated to apply heat to a material that is extruded through the nozzle to form the product item. As a result, such a 3D printer may make use of a configuration parameter or setting corresponding to the nozzle temperature.

Other types of 3D printers that do not include any nozzle (e.g., a 3D printer that uses a vat polymerization process, such as stereolithography or direct light processing) may not include any parameter or setting corresponding to a nozzle temperature. Thus, not only the values of the configuration parameters, but also the types of configuration parameters themselves, may vary across different 3D printers. In some implementations, the server can maintain different sets of configuration parameters for the respective 3D printers depending on the types of configuration parameters or settings that may be useful or necessary for each particular 3D printer. In some implementations, at least some of the configuration parameters that are not necessary for a particular 3D printer may be omitted from the set of configuration parameters stored by the server for that 3D printer. In addition, there may be some parameters that are useful or necessary for all 3D printers (e.g., parameters relating to possible layer heights), and therefore the server may store those parameters for each 3D printer for which it maintains a respective set of configuration parameters.

The method can include transforming each raw data set into a respective data file having a predetermined file format (BLOCK 515). In some implementations, this action can be performed by the server. In some implementations, the predetermined file format can be selected based on the set of configuration parameters for the 3D printer. For example, the 3D printer can be configured to read or accept files having a particular format or file type, and the predetermined file format can be selected to be compatible with the 3D printer. In some implementations, each data file can include information corresponding to images of a plurality of layers of the respective 3D object. For example, the server can be configured to generate a plurality of layers based on the raw data for each 3D object. The layers can represent sequential slices of the object, and each slice can represent a single material deposition layer able to be produced by the 3D printer. Thus, by depositing layers corresponding to the slices in a sequential fashion, the 3D printer can produce the entire 3D object. In some implementations, the method 500 can include selecting a layer thickness for each raw data set of the plurality of raw data sets. The layer thickness can be selected based on the set of configuration parameters for the 3D printer. In some implementations the images of the plurality of layers of each respective 3D object can be selected based on the selected layer thickness.

In some implementations, each data file can also include printer instructions for manufacturing the respective 3D object using the 3D printer. For example, in addition to images for each layer, the data file can include information to be used by the 3D printer to deposit the sequential layers of material. In some implementations, such information can include a material (e.g., an ink) to be used for each layer, a temperature at which each layer should be deposited, an amount of time to wait between depositing adjacent layers, etc. In some implementations, the server can also generate support material instructions for at least one 3D object. For example, support material instructions can corresponding to material to be included in negative space of the 3D object. In some implementations, support material can help to provide structural support for the resulting 3D object. In some implementations, the method can include generating, by the server, the respective data file for the at least one 3D object to include the support material instructions. In some implementations, the server can also generate each data file to include features such as data rights management information and encryption information that may be compatible with the predetermined file format.

In implementations in which the server stores more than one set of configuration parameters for additional 3D printers, the server can also be configured to transform each raw data set of the plurality of raw data sets into additional data files, which may have different predetermined file formats selected based on the additional sets of configuration parameters for the additional 3D printers. Each additional data file can include information corresponding to images of a plurality of layers of the respective 3D object and printer instructions for manufacturing the respective 3D object using the respective additional 3D printer. Thus, the server can create and store more than one data file for a single 3D object, and each data file can correspond to a particular type of 3D printer having its own configuration parameters.

In some implementations, rather than automatically transforming a raw data file into a file having a predetermined file format for a particular 3D printer, the server can instead receive a file having the predetermined file format for that printer, for example by receiving the file directly from a developer who designed the 3D object associated with the file. Thus, the developer may create a 3D file having a file format suitable for use with a particular 3D printer, and may transmit that file to the server along with an identification of the type of printer that corresponds to the file. In some implementations, for a single 3D object, the developer may create additional files with different predetermined file formats corresponding to other 3D printers as well. Thus, for a single 3D object, a developer may generate multiple files, each conforming to a predetermined file format selected for compatibility with a respective printer type. All of these files can be transmitted to the server, which can save the files for future use.

The method can include receiving a request to build a selected one of the 3D objects (BLOCK 520). The request can be received by the server, for example from a user computing device. The request can be received via a wireless communication protocol, for example using a cellular network or Wi-Fi. In some implementations, the user can be enabled to browse a catalog including the plurality of 3D objects, and can select from the catalog one or more of the 3D objects to be built. In some implementations, the server can provide a 3D printing application for installation on the user computing device. The 3D printing application can cause the user computing device to display a user interface including the catalog of the plurality of 3D objects. In some implementations, the user can interact with the user interface to make a selection of one of the 3D objects that the user wishes to build, and the server can receive the request to build the selected one of the 3D objects responsive to the user interaction. For example, the user can interact with the user interface to cause the user computing device to send the request to the server.

In implementations in which the server stores additional configuration parameters for additional 3D printer types, the server can also determine which 3D printer type is associated with the request. For example, the request can include an indication of a type of 3D printer owned by or otherwise accessible to the user that generated the request. The server can be configured to select the data file that corresponds to the user's printer type so that the data file can be compatible with the user's 3D printer.

The method can include transmitting the corresponding data file to the 3D printer (BLOCK 525). In some implementations, the server can transmit the data file to the 3D printer via a wireless communication network, such as Wi-Fi. Transmitting the data file to the 3D printer can cause the 3D printer to automatically print the corresponding 3D object. For example, upon receiving the data file, the 3D printer can be configured to implement the instructions in the data file to build the 3D object as a series of successive layers of materials deposited over one another by the 3D printer.

In some implementations, the 3D printer may not be able to print the 3D object. Thus, the server may determine an error condition that prohibits the 3D printer from manufacturing the 3D object that the user requested, and may notify the user of the error condition rather than sending the corresponding data file to the 3D printer. For example, the server can identify the error condition based on either or both of the request or the set of configuration parameters for the 3D printer. In some implementations, the error condition may arise because the 3D printer does not have enough ink or does not have the correct type of ink to manufacture the selected 3D object. In some implementations, when the server transmits the information corresponding to the error condition to the user computing device, the user computing device can display an indication of the error condition.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are exemplary and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the exemplary embodiments and should be defined in accordance with the accompanying claims and their equivalents.

What is claimed is:

1. A system for manufacturing a three-dimensional (3D) object, comprising:
a server intermediary to a 3D printer and a user computing device, the server configured to:
receive a plurality of raw data sets each corresponding to a respective 3D object;
store a set of configuration parameters for a 3D printer, the set of configuration parameters corresponding to settings of the 3D printer;
transform each raw data set of the plurality of raw data sets into a respective data file having a predetermined file format selected based on the set of configuration parameters for the 3D printer, wherein each data file comprises information corresponding to images of a plurality of layers of the respective 3D object and printer instructions for manufacturing the respective 3D object using the 3D printer;
receive, from the user computing device, a request to build a selected one of the 3D objects; and
transmit, to the 3D printer responsive to the request, the data file corresponding to the selected 3D object to cause the 3D printer to manufacture the selected 3D object based on the printer instructions included in the corresponding data file.

2. The system of claim 1, wherein the server is further configured to:
select a layer thickness for each raw data set of the plurality of raw data sets, based on the set of configuration parameters for the 3D printer; and
generate the images of the plurality of layers of each respective 3D object based on the selected layer thickness.

3. The system of claim 1, wherein the set of configuration parameters for the 3D printer includes static data comprising at least one of a printer bed temperature, a printer bed size, a printer height, or a number of possible cartridges for the 3D printer.

4. The system of claim 3, wherein the set of configuration parameters for the 3D printer further includes dynamic data comprising at least one of a volume of ink remaining in one or more cartridges, a type of ink in the one or more cartridges, a number of cartridges, or a real time temperature of a heatbed of the 3D printer.

5. The system of claim 1, wherein the server is further configured to:
generate, for at least one of the 3D objects, support material instructions corresponding to material to be included in negative space of the 3D object; and
generate the respective data file for the at least one 3D object to include the support material instructions.

6. The system of claim 1, wherein the server is further configured to generate each data file to include at least one of data rights management information and encryption information compatible with the predetermined file format.

7. The system of claim 1, wherein the server is further configured to:
provide a 3D printing application for installation on the user computing device, the 3D printing application configured to cause the user computing device to display a user interface comprising a catalog of the plurality of 3D objects; and
receive, from the user computing device, the request to build the selected one of the 3D objects responsive to a user interaction with the user interface displayed on the user computing device.

8. The system of claim 1, wherein the server is further configured to:
receive, from the user computing device, a second request to build a second selected 3D object;
determine an error condition that prohibits the 3D printer from manufacturing the second selected 3D object, based on the second request and the set of configuration parameters for the 3D printer; and
transmit, responsive to determining the error condition, information to the user computing device to cause the user computing device to display an indication of the error condition.

9. The system of claim 1, wherein the 3D printer is a first 3D printer, and wherein the server is further configured to:
store a second set of configuration parameters for a second 3D printer, the second set of configuration parameters corresponding to settings of the second 3D printer; and
transform each raw data set of the plurality of raw data sets into a respective second data file having a second predetermined file format selected based on the second set of configuration parameters for the second 3D printer, wherein each second data file comprises information corresponding to images of a plurality of layers of the respective 3D object and printer instructions for manufacturing the respective 3D object using the second 3D printer.

10. The method of claim 9, wherein the user computing device is a first user computing device, and wherein the server is further configured to:
receive, from a second user computing device, a second request to build a second selected one of the 3D objects; and
transmit, to the second 3D printer responsive to the second request, the second data file corresponding to the second selected 3D object to cause the second 3D printer to manufacture the second selected 3D object based on the printer instructions included in the corresponding second data file.

11. A method of manufacturing a three-dimensional (3D) object, comprising:
receiving, by a server, a plurality of raw data sets each corresponding to a respective 3D object;
storing, by the server, a set of configuration parameters for a 3D printer, the set of configuration parameters corresponding to settings of the 3D printer;
transforming, by the server, each raw data set of the plurality of raw data sets into a respective data file having a predetermined file format selected based on the set of configuration parameters for the 3D printer, wherein each data file comprises information corresponding to images of a plurality of layers of the respective 3D object and printer instructions for manufacturing the respective 3D object using the 3D printer;
receiving, by the server from a user computing device, a request to build a selected one of the 3D objects; and
transmitting, by the server to the 3D printer responsive to the request, the data file corresponding to the selected 3D object to cause the 3D printer to manufacture the selected 3D object based on the printer instructions included in the corresponding data file.

12. The method of claim 11, further comprising:
selecting, by the server, a layer thickness for each raw data set of the plurality of raw data sets, based on the set of configuration parameters for the 3D printer; and
generating, by the server, the images of the plurality of layers of each respective 3D object based on the selected layer thickness.

13. The method of claim 11, wherein the set of configuration parameters for the 3D printer includes static data comprising at least one of a printer bed temperature, a printer bed size, a printer height, or a number of possible cartridges for the 3D printer.

14. The method of claim 13, wherein the set of configuration parameters for the 3D printer further includes dynamic data comprising at least one of a volume of ink remaining in one or more cartridges, a type of ink in the one or more cartridges, a number of cartridges, or a real time temperature of a heatbed of the 3D printer.

15. The method of claim 11, further comprising:
generating, by the server for at least one of the 3D objects, support material instructions corresponding to material to be included in negative space of the 3D object; and
generating, by the server, the respective data file for the at least one 3D object to include the support material instructions.

16. The method of claim 11, further comprising generating, by the server, each data file to include at least one of data rights management information and encryption information compatible with the predetermined file format.

17. The method of claim 11, further comprising:
providing a 3D printing application for installation on the user computing device, the 3D printing application configured to cause the user computing device to display a user interface comprising a catalog of the plurality of 3D objects; and
receiving, by the server from the user computing device, the request to build the selected one of the 3D objects responsive to a user interaction with the user interface displayed on the user computing device.

18. The method of claim 11, further comprising:
receiving, by the server from the user computing device, a second request to build a second selected 3D object;
determining, by the server, an error condition that prohibits the 3D printer from manufacturing the second selected 3D object, based on the second request and the set of configuration parameters for the 3D printer; and
responsive to determining the error condition, transmitting information by the server to the user computing device to cause the user computing device to display an indication of the error condition.

19. The method of claim 11, wherein the 3D printer is a first 3D printer, the method further comprising:
storing, by the server, a second set of configuration parameters for a second 3D printer, the second set of configuration parameters corresponding to settings of the second 3D printer; and
transforming, by the server, each raw data set of the plurality of raw data sets into a respective second data file having a second predetermined file format selected based on the second set of configuration parameters for the second 3D printer, wherein each second data file comprises information corresponding to images of a plurality of layers of the respective 3D object and printer instructions for manufacturing the respective 3D object using the second 3D printer.

20. The method of claim 19, wherein the user computing device is a first user computing device, the method further comprising:
receiving, by the server from a second user computing device, a second request to build a second selected one of the 3D objects; and
transmitting, by the server to the second 3D printer responsive to the second request, the second data file corresponding to the second selected 3D object to cause the second 3D printer to manufacture the second selected 3D object based on the printer instructions included in the corresponding second data file.
